(19) United States
(12) Patent Application Publication
(10) Pub. No.: US 2017/0272369 A1
(43) Pub. Date: Sep. 21, 2017

(54) APPARATUS AND METHOD FOR GENERATING PHOTONIC FRAME

(71) Applicant: ELECTRONICS AND TELECOMMUNICATIONS RESEARCH INSTITUTE, Daejeon (KR)

(72) Inventors: Ji Wook YOUN, Daejeon (KR); Je Soo KO, Daejeon (KR); Kwang Joon KIM, Daejeon (KR); Dae Ub KIM, Daejeon (KR)

(21) Appl. No.: 15/402,313

(22) Filed: Jan. 10, 2017

(30) Foreign Application Priority Data
Mar. 17, 2016 (KR) 10-2016-0031789

(51) Int. Cl. H04L 12/851; H04J 14/02; H04Q 11/00

(52) U.S. Cl. CPC H04L 47/2441; H04Q 11/0005; H04J 14/0212; H04Q 2011/0088

(57) ABSTRACT

An apparatus and method for generating a photonic frame from input packet data based on a wavelength, a space and a time and for transmitting an optical signal based on a structure of the photonic frame. The apparatus includes a classifier configured to classify input packet signals based on destination information of the packet signals, and a processor configured to generate a first frame by converting each of the classified packet signals to a photonic frame based on at least one of wavelength information and port information available for each of the packet signals.

### CROSS-REFERENCE TO RELATED APPLICATION

This application claims the benefit of Korean Patent Application No. 10-2016-0031789, filed on Mar. 17, 2016, in the Korean Intellectual Property Office, the disclosure of which is incorporated herein by reference.

### BACKGROUND

1. Field of the Invention

Embodiments relate to a technology for implementing an optical switching-based network, and more particularly, to an apparatus and method for generating a photonic frame based on a wavelength, a space and a time, and transmitting the photonic frame using an optical switch.

2. Description of Related Art

Currently, a large capacity of an optical transport network is being required to accept packet data that is dramatically increasing. Also, a necessity for an ultra low latency network to provide a hyper-connected realistic service required in a 5^{th} generation (5G) network is increasing. To respond to the above requirements, research on applying of an all-optical switch to a transport network has been conducted all over the world.

All-optical switch-based switching schemes are broadly classified into an optical circuit switching (OCS) scheme, an optical packet switching (OPS) scheme and an optical burst switching (OBS) scheme. The OCS scheme may be used when a light path remains unchanged for a longer period of time, and a scheme of using a wavelength selective switch (WSS) or a microelectromechanical system (MEMS) switch may be mainly studied. The OPS scheme may be used to electrically process an optical header portion separated from an optical signal (for example, a payload) and to switch an optical packet in each switching node.

The OPS scheme has advantages in that a low latency service is available and a short switching time and a flexibility of a network are provided. However, since an optical buffer needs to be added to prevent a collision between packets in each switching node and a complex optical header processing technology is required, a commercialization of the OPS scheme is limited. The OBS scheme is proposed to compensate for a limitation of the OPS scheme, and has an advantage in that an optical buffer is not used. However, in the OBS scheme, complexity in a burst traffic control process rapidly increases when a number of switching nodes increases, a burst size is variable and it is difficult to generate high-speed burst traffic. Thus, there is a desire for a new optical switching technology for effectively accepting a large quantity of traffic and providing an ultra low latency service while maintaining a flexibility of a packet switch and an efficiency of a network.

### SUMMARY

According to an aspect, there is provided a photonic frame generation apparatus for generating a photonic frame from input packet data based on a wavelength, a space and a time and for transmitting an optical signal based on a structure of the photonic frame. The photonic frame generation apparatus may include a classifier configured to classify input packet signals based on destination information of the packet signals, and a processor configured to generate a first frame by converting each of the classified packet signals to a photonic frame based on at least one of wavelength information and port information available for each of the packet signals.

The classifier may be configured to store the packet signals in first buffers allocated by destinations, based on the destination information.

The processor may be configured to assign a frame identification (ID) to the generated first frame.

The processor may be configured to assign the frame ID to the first frame by additionally using available time information corresponding to port information of the first frame.

The processor may be configured to perform scheduling of the first frame based on at least one of the wavelength information and the port information, and to output the first frame of which the scheduling is performed to second buffers allocated by frame IDs.

The photonic frame generation apparatus may further include a transmitter configured to convert an optical wavelength of the first frame and to transmit the first frame with the converted optical wavelength to a destination.

According to another aspect, there is provided a photonic frame generation apparatus for generating a photonic frame from input data including a plurality of packets, based on a wavelength, a space and a time. The photonic frame generation apparatus may include a classifier configured to classify a plurality of packets included in input data based on destination information of the plurality of packets, and a processor configured to generate a first frame by converting each of first packets having the same destination information among the plurality of packets to a photonic frame, and to assign a frame ID to the first frame based on at least one of wavelength information and port information available for the first frame.

The classifier may be configured to classify the plurality of packets based on the destination information and to store the classified packets in a destination buffer.

The processor may be configured to map the first packets to a payload portion of the first frame.

The processor may be configured to assign the frame ID to the first frame by additionally using available time information corresponding to the port information.

The processor may be configured to perform scheduling of the first frame based on at least one of the wavelength information and the port information, and to output the first frame of which the scheduling is performed to an ID buffer allocated by frame IDs.

According to another aspect, there is provided a method of generating a photonic frame from input packet data based on a wavelength, a space and a time and of transmitting an optical signal based on a structure of the photonic frame. The method may include classifying first packets included in an input packet signal based on destination information of the first packets, and generating a first frame by converting each of the classified first packets to a photonic frame based on at least one of wavelength information and port information available for each of the first packets.

The classifying may include storing the first packets in first buffers allocated by destinations, based on the destination information.

The generating may include assigning a frame ID to the first frame based on at least one of the wavelength information and the port information.

The assigning may include assigning the frame ID to the first frame by additionally using available time information corresponding to port information of the first frame.

The generating may include performing scheduling of the first frame based on at least one of the wavelength information and the port information, and outputting the first frame of which the scheduling is performed to second buffers allocated by frame IDs.

The method may further include converting an optical wavelength of the first frame and transmitting the first frame with the converted optical wavelength to a destination.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a photonic frame generation apparatus according to an embodiment;

FIG. 2 is a diagram illustrating a configuration of a photonic frame generation apparatus according to an embodiment;

FIG. 3 is a diagram illustrating a structure of a photonic frame according to an embodiment;

FIG. 4 is a diagram illustrating a process of switching photonic frames between destination devices according to an embodiment; and

FIG. 5 is a flowchart illustrating a photonic frame generation method according to an embodiment.

### DETAILED DESCRIPTION

Particular structural or functional descriptions of embodiments according to the concept of the present disclosure disclosed in the present disclosure are merely intended for the purpose of describing embodiments according to the concept of the present disclosure and the embodiments according to the concept of the present disclosure may be implemented in various forms and should not be construed as being limited to those described in the present disclosure.

Though embodiments according to the concept of the present disclosure may be variously modified and be several embodiments, specific embodiments will be shown in drawings and be explained in detail. However, the embodiments are not meant to be limited, but it is intended that various modifications, equivalents, and alternatives are also covered within the scope of the claims.

Although terms of “first,” “second,” etc. are used to explain various components, the components are not limited to such terms. These terms are used only to distinguish one component from another component. For example, a first component may be referred to as a second component, or similarly, the second component may be referred to as the first component within the scope of the right according to the concept of the present disclosure.

When it is mentioned that one component is “connected” or “accessed” to another component, it may be understood that the one component is directly connected or accessed to another component or that still other component is interposed between the two components. Also, when it is mentioned that one component is “directly connected” or “directly accessed” to another component, it may be understood that no component is interposed therebetween. Expressions used to describe the relationship between components should be interpreted in a like fashion, for example, “between” versus “directly between,” or “adjacent to” versus “directly adjacent to.”

The terminology used herein is for the purpose of describing particular embodiments only and is not intended to be limiting of embodiments. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. The scope of the right, however, should not be construed as limited to the embodiments set forth herein. Regarding the reference numerals assigned to the elements in the drawings, it should be noted that the same elements will be designated by the same reference numerals.

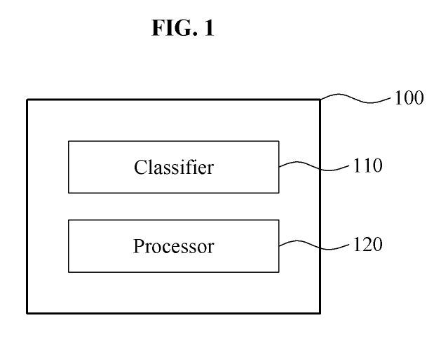

FIG. 1 is a block diagram illustrating a photonic frame generation apparatus 100 according to an embodiment.

The photonic frame generation apparatus 100 may be configured to generate a photonic frame from input packet data based on a wavelength, a space and a time, and to generate an optical signal based on a structure of the photonic frame. The photonic frame generation apparatus 100 may include a classifier 110, a processor 120 and a transmitter (not shown). However, since the transmitter is an optional component, the transmitter is not included in the photonic frame generation apparatus 100. In the following description, a “photonic frame” may be referred to as a “PF.”

The classifier 110 may classify input packet signals based on destination information included in the packet signals. The classifier 110 may store the packet signals in first buffers allocated by destinations in a destination buffer, based on the destination information.

The processor 120 may convert each of the packet signals to a structure of a photonic frame based on information about resources and an operation of a network via which the packet signals are transmitted and received. For example, the processor 120 may convert each of the classified packet signals to a photonic frame based on at least one of wavelength information and port information available for each of the packet signals, and may generate a first fame.

Also, the processor 120 may assign a frame identification (ID) to the generated first frame. To assign the frame ID, the processor 120 may use available time information corresponding to port information of the first frame, in addition to the destination information, the wavelength information and the port information. In an example, even though packet signals have the same destination information, different frame IDs may be assigned based on selected port information or selected wavelength information. In another example, even though packet signals have the same port information and the same wavelength information, different frame IDs may be assigned based on available time information. The processor 120 may perform scheduling of the first frame based on at least one of the wavelength information and the port information, and may output the first frame of which the scheduling is performed to second buffers allocated by frame IDs in an ID buffer.

For example, the photonic frame generation apparatus 100 may convert input data including a plurality of packets to a structure of a photonic frame. In this example, the classifier 110 may classify the plurality of packets in the input data based on destination information of each of the plurality of packets. The classifier 110 may classify the plurality of packets based on the destination information and may store the classified packets in a destination buffer. The processor 120 may generate a first frame by converting each of first packets classified to have the same destination information among the plurality of packets to a photonic frame. The processor 120 may map the first packets to a payload portion of the first frame, to convert the input data to the structure of the photonic frame. Also, the processor 120 may assign a frame ID to the first frame based on at least one of wavelength information and port information available for the first frame, may perform scheduling the first frame based on at least one of the wavelength information and the port information, and may output the first frame of which the scheduling is performed to ID buffers allocated by frame IDs. To assign the frame ID to the first frame, the processor 120 may additionally use available time information corresponding to the port information for the first frame. In an example, even though packets have the same destination information, different frame IDs may be assigned based on available port information or available wavelength information. Also, even though a plurality of packets have the same port information and the same wavelength information, different frame IDs may be assigned based on available time information.

The transmitter may convert an optical wavelength of the first frame and may transmit the first frame with the converted optical wavelength to a destination.

The photonic frame generation apparatus 100 may generate a photonic frame from an input packet signal based on a wavelength, a space and a time, may generate an optical signal based on the photonic frame and may switch the optical signal in an optical switching system for switching an optical signal. Thus, the photonic frame generation apparatus 100 may not require an optical buffer and a complex optical header processing function which are limits of an existing technology. Also, the photonic frame generation apparatus 100 may form a photonic frame structure-based optical switching network, and thus it is possible to provide an optical switching system that has a simpler structure and that is easily commercialized.

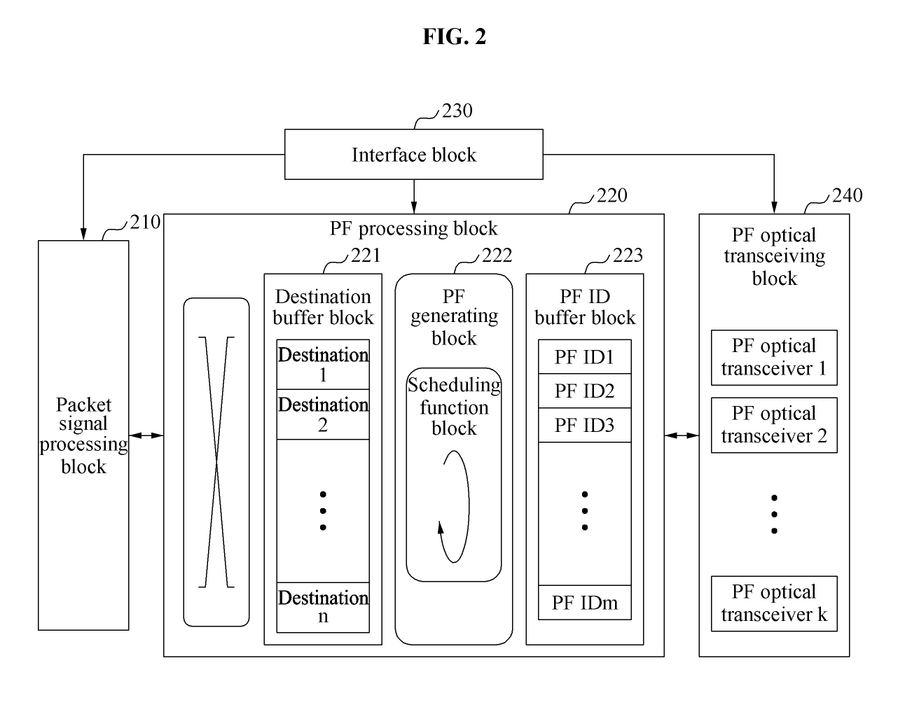

FIG. 2 is a diagram illustrating a configuration of a photonic frame generation apparatus according to an embodiment.

Referring to FIG. 2, the photonic frame generation apparatus may include a packet signal processing block 210, a PF processing block 220, an interface block 230 and a PF optical transceiving block 240. The PF processing block 220 may include a destination buffer block 221, a PF generating block 222 and a PF ID buffer block 223.

The packet signal processing block 210 may classify packet signals received from a plurality of external devices based on destination information of the packet signals, and may transfer the packet signals to the PF processing block 220. The classified packet signals may be stored in buffers allocated by destinations in the destination buffer block 221 of the PF processing block 220.

The PF processing block 220 may generate a photonic frame by converting each of the classified packet signals to a structure of a photonic frame based on network resource information and network operation information received from the interface block 230. The photonic frame may be generated based on available wavelength information or available port information (for example, a state of a current network) in addition to the destination information of the packet signals. The PF processing block 220 may assign a PF ID to the generated photonic frame based on at least one of the destination information, the wavelength information and the port information. In an example, even though packet signals have the same destination information, different frame IDs may be assigned based on available port information or available wavelength information. In another example, even though the packet signals have the same port information and the same wavelength information, different frame IDs may be assigned based on available time information. The photonic frame ID may be subdivided based on available time for each port and may be assigned, and different photonic frame IDs may be assigned based on a time at which photonic frames are generated even though the photonic frames have the same port information and the same wavelength information.

The PF generating block 222 may assign a PF ID to the generated photonic frame, may perform scheduling of the photonic frame based on network operation information including the port information and the wavelength information, and may output the photonic frame to buffers allocated by frame IDs in the PF ID buffer block 223.

The PF optical transceiving block 240 may include a plurality of PF optical transceivers. The PF optical transceivers may convert an optical wavelength of the photonic frame based on time information and wavelength information received from the interface block 230 and the PF processing block 220, and may output the photonic frame to an optical transceiver that enables a high-speed wavelength conversion.

As described above, the photonic frame generation apparatus may generate a photonic frame based on a wavelength, a time and a space (for example, a port) from an input packet signal, and thus may have an advantage in that an optical header including information used to switch an optical packet in an existing optical switching network and a complex process of processing the optical header are not required.

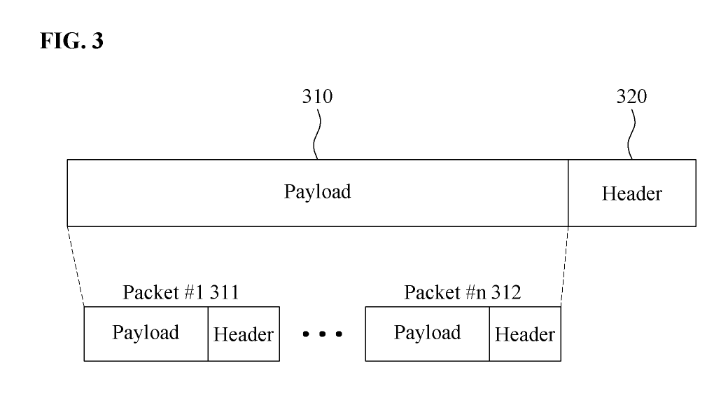

FIG. 3 is a diagram illustrating a structure of a generated photonic frame according to an embodiment.

In FIG. 3, the photonic frame may include a payload portion 310 and a header portion 320.

The photonic frame may include packets with the same destination information. A plurality of packets, for example, packets 311 and 312, classified to have the same destination information may be included in the payload portion 310 of the photonic frame. A single packet, or a plurality of packets having the same destination information may be mapped to the payload portion 310. The header portion 320 may include sync information and a preamble function to process the photonic frame in a receiver.

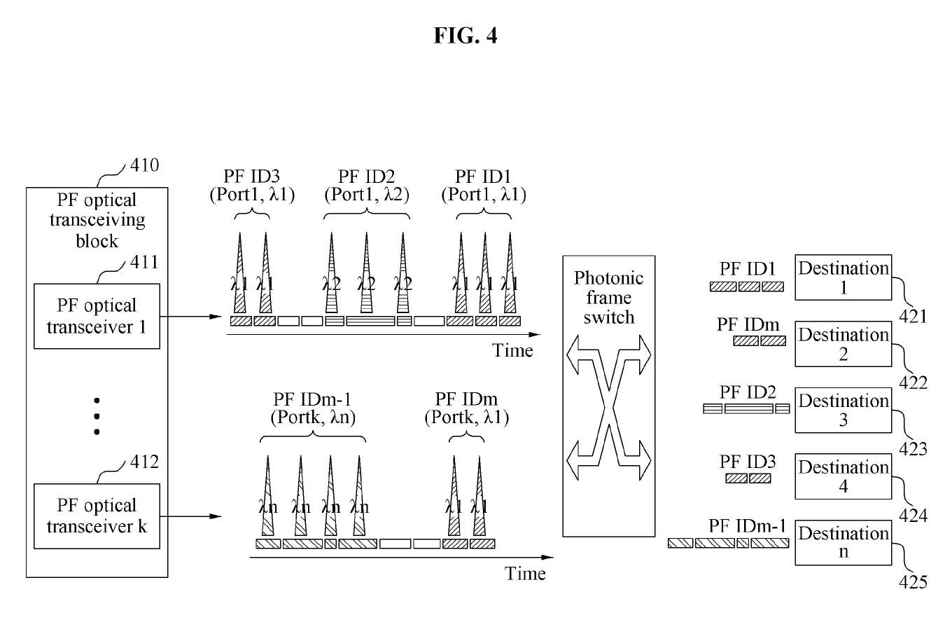

FIG. 4 is a diagram illustrating a process of switching photonic frames between destination devices according to an embodiment.

As described above with reference to FIG. 2, the PF processing block 220 may generate a photonic frame by converting an input packet signal to a structure of the photonic frame based on network operation information received from the interface block 230, and may assign a PF ID to the generated photonic frame based on at least one of destination information, the wavelength information and the port information.

Photonic frames generated as described above may be transmitted to destinations of the photonic frames using a PF optical transceiving block 410 of FIG. 4. The photonic frames may be classified based on port information and may be assigned to a plurality of PF optical transceivers included in the PF optical transceiving block 410. For example, photonic frames to which a PF ID1, a PF ID2 and a PF ID3 are assigned and that have the same port information, for example, port information port 1, may be transmitted using a PF optical transceiver 1 411 among the plurality of PF optical transceivers. In another example, photonic frames to which a PF IDm-1 and a PF IDm are assigned and that have port information port k may be transmitted using a PF optical transceiver k 412 among the plurality of PF optical transceivers.

In FIG. 4, since the photonic frames with the PF ID1 and the PF ID2 have different wavelength information even though the same port is used to output the photonic frames with the PF ID1 and the PF ID2, the photonic frames with the PF ID1 and the PF ID2 may be switched to different destination devices (for example, a destination 1 421 and a destination 3 423). Similarly, since the photonic frames with the PF IDm-1 and the PF IDm have different wavelength information even though the same port is used to output the photonic frames with the PF IDm-1 and the PF IDm, the photonic frames with the PF IDm-1 and the PF IDm may be switched to different destination devices (for example, a destination n 425 and a destination 2 422). In addition, since the photonic frames with the PF ID1 and the PF ID3 are output at different times even though the same port and the same wavelength are used, the photonic frames with the PF ID1 and the PF ID3 may be switched to different destination devices (for example, the destination 1 421 and a destination 4 424). Furthermore, since different ports are used to output the photonic frames with the PF ID1 and the PF IDm even though the photonic frames with the PF ID1 and the PF IDm are output at the same time based on the same wavelength, the photonic frames with the PF ID1 and the PF IDm may be switched to different destination devices (for example, the destination 1 421 and the destination 2 422).

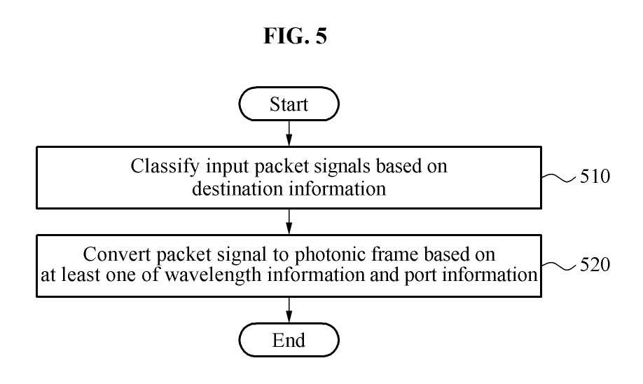

FIG. 5 is a flowchart illustrating a photonic frame generation method according to an embodiment.

The photonic frame generation method may be performed by a photonic frame generation apparatus according to an embodiment to generate a photonic frame from input packet data based on a wavelength, a space and a time and to switch an optical signal based on a structure of the photonic frame.

Referring to FIG. 5, in operation 510, a classifier of the photonic frame generation apparatus may classify first packets included in an input packet signal based on destination information included in the first packets. In operation 510, the classifier may store the first packets in first buffers allocated by destinations in a destination buffer, based on the destination information.

In operation 520, a processor of the photonic frame generation apparatus may generate a first frame by converting each of the classified first packets to a structure of a photonic frame based on at least one of wavelength information and port information available for each of the first packets. In operation 520, the processor may assign a frame ID to the first frame. To assign the frame ID, the processor may use available time information corresponding to port information of the first frame, in addition to the destination information, the wavelength information and the port information. In an example, even though packet signals have the same destination information, different frame IDs may be assigned based on available port information or available wavelength information. In another example, even though packet signals have the same port information and the same wavelength information, different frame IDs may be assigned based on available time information.

Also, in operation 520, the processor may perform scheduling of the first frame based on at least one of the wavelength information and the port information, and may output the first frame of which the scheduling is performed to second buffers allocated by frame IDs in an ID buffer.

When operation 520 is performed, a transmitter of the photonic frame generation apparatus may convert an optical wavelength of the first frame and may transmit the first frame with the converted optical wavelength to a destination.

The units described herein may be implemented using hardware components, software components, or a combination thereof. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A photonic frame generation apparatus comprising:
a classifier configured to classify input packet signals based on destination information of the packet signals; and
a processor configured to generate a first frame by converting each of the classified packet signals to a photonic frame based on at least one of wavelength information and port information available for each of the packet signals.

2. The photonic frame generation apparatus of claim 1, wherein the classifier is configured to store the packet signals in first buffers allocated by destinations, based on the destination information.

3. The photonic frame generation apparatus of claim 1, wherein the processor is configured to assign a frame identification (ID) to the generated first frame.

4. The photonic frame generation apparatus of claim 3, wherein the processor is configured to assign the frame ID to the first frame by additionally using available time information corresponding to port information of the first frame.

5. The photonic frame generation apparatus of claim 1, wherein the processor is configured to perform scheduling of the first frame based on at least one of the wavelength information and the port information, and to output the first frame of which the scheduling is performed to second buffers allocated by frame IDs.

6. The photonic frame generation apparatus of claim 1, further comprising:
a transmitter configured to convert an optical wavelength of the first frame and to transmit the first frame with the converted optical wavelength to a destination.

7. A photonic frame generation apparatus comprising:
a classifier configured to classify a plurality of packets included in input data based on destination information of the plurality of packets; and
a processor configured to generate a first frame by converting each of first packets having the same destination information among the plurality of packets to a photonic frame, and to assign a frame identification (ID) to the first frame based on at least one of wavelength information and port information available for the first frame.

8. The photonic frame generation apparatus of claim 7, wherein the classifier is configured to classify the plurality of packets based on the destination information and to store the classified packets in a destination buffer.

9. The photonic frame generation apparatus of claim 7, wherein the processor is configured to map the first packets to a payload portion of the first frame.

10. The photonic frame generation apparatus of claim 7, wherein the processor is configured to assign the frame ID to the first frame by additionally using available time information corresponding to the port information.

11. The photonic frame generation apparatus of claim 7, wherein the processor is configured to perform scheduling of the first frame based on at least one of the wavelength information and the port information, and to output the first frame of which the scheduling is performed to an ID buffer allocated by frame IDs.

12. A photonic frame generation method comprising:
classifying first packets included in an input packet signal based on destination information of the first packets; and
generating a first frame by converting each of the classified first packets to a photonic frame based on at least one of wavelength information and port information available for each of the first packets.

13. The photonic frame generation method of claim 12, wherein the classifying comprises storing the first packets in first buffers allocated by destinations, based on the destination information.

14. The photonic frame generation method of claim 12, wherein the generating comprises assigning a frame identification (ID) to the first frame based on at least one of the wavelength information and the port information.

15. The photonic frame generation method of claim 14, wherein the assigning comprises assigning the frame ID to the first frame by additionally using available time information corresponding to port information of the first frame.

16. The photonic frame generation method of claim 12, wherein the generating comprises performing scheduling of the first frame based on at least one of the wavelength information and the port information, and outputting the first frame of which the scheduling is performed to second buffers allocated by frame IDs.

17. The photonic frame generation method of claim 12, further comprising:
converting an optical wavelength of the first frame and transmitting the first frame with the converted optical wavelength to a destination.
